(19) United States
(12) Patent Application Publication
(10) Pub. No.: US 2014/0324530 A1
(43) Pub. Date: Oct. 30, 2014

(54) METHOD AND SYSTEM FOR DETECTING PATTERS IN DATA STREAMS

(71) Applicant: LIVEOPS, INC., REDWOOD CITY, CA (US)

(72) Inventors: Jeffrey M. THOMPSON, Fredericton (CA); Robin A. Bate BOEROP, Fredericton (CA); Trevor X. BERNARD, Fredericton (CA); Joshua J. COMER, Fredericton (CA); Ian E. BISHOP, Fredericton (CA)

(73) Assignee: LIVEOPS, INC., REDWOOD CITY, CA (US)

(21) Appl. No.: 14/264,719

(22) Filed: Apr. 29, 2014

Related U.S. Application Data
(60) Provisional application No. 61/817,538, filed on Apr. 30, 2013.

(51) Int. Cl. G06Q 30/02

(52) U.S. Cl. CPC G06Q 30/0201
USPC 705/7.29

(57) ABSTRACT

A new approach is proposed that contemplates systems and methods to detect patterns in at least one data stream. First, the at least one data stream is received and analyzed to detect an event in the least one data stream, wherein the detected event occurs in relation with an entity and includes at least one attribute indicative of at least one of an identity of the entity, an event type, and contact information for the entity. Once the event is detected and/or received from an external source, it is compared with a plurality of predefined patterns to determine if a match between the event and at least one of the predefined patterns is found. If a match is found successfully, a notification indicative of the entity and/or the event and the at least one predefined pattern that has been successfully matched with the event is generated and transmitted with instructions for actions by another application.

### CROSS-REFERENCE TO RELATED APPLICATIONS

This application claims the benefit of U.S. Provisional Patent Application No. 61/817,538, filed Apr. 30, 2013, and entitled “Method and system for detecting patterns in data streams,” and is hereby incorporated herein by reference.

### BACKGROUND

Data streams representing interactions between a customer and a business across all touch points are collected from medias including but are not limited to inbound voice calls, emails, social media, mobile and web application platforms. When the interactions between the customer and the business result in a negative outcome, for non-limiting examples, failure to purchase an item or check-in for a flight, such outcome may affect continued customer loyalty or impair further sales/revenue with that customer. The business thus needs to analyze the data streams for events that may require notification to and response/action by the business and/or the customer. For example, certain patterns need to be configured and detected in the data streams to monitor customer interactions across all touch points over any period of time. In some systems for detecting patterns in the data streams, “windows” (sequences) of data from the data streams are received and stored before being analyzed. However, having to partition the data streams into discrete windows reduces pattern detection flexibility and performance. Additionally, the task of specifying patterns worthy of detection is technically challenging, and not suited to non-technical business users. This renders the process of specifying patterns a slow, expensive business practice which usually requires technical expertise. Therefore, there is a need for an improved method and system for detecting/identifying patterns in data streams.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of system 100 to support pattern detection in a single or multiple streams of data in accordance with some embodiments.

FIG. 2 depicts a flowchart of an example of a process to support pattern detection in a single or multiple streams of data in accordance with some embodiments.

FIG. 3 illustrates an example of a platform 300 to support the implementation of the system 100 depicted in FIG. 1 for pattern detection in a single or multiple streams of data in accordance with some embodiments.

FIG. 4 depicts an example of an acknowledgement receipt of an event data received back to the external data source once the event has been processed in accordance with some embodiments.

FIG. 5 depicts an example of various stages in a lifecycle of an event record in accordance with some embodiments.

FIG. 6 is an example of a flow illustrating the process of handling notifications in accordance with some embodiments.

FIG. 7 illustrates an example of dimensions or configuration objects of statistical results in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to detect patterns in at least one data stream. First, the at least one data stream is received and analyzed to detect an event in the least one data stream, wherein the detected event occurs in relation with an entity and includes at least one attribute indicative of at least one of an identity of the entity, an event type, and contact information for the entity. Once the event is detected and/or received from an external source, it is compared with a plurality of predefined patterns to determine if a match between the event and at least one of the predefined patterns is found. If a match is found successfully, a notification indicative of the entity and/or the event and the at least one predefined pattern that has been successfully matched with the event is generated and transmitted with instructions for actions by another application.

The proposed approach detects the behavior patterns in the data stream in real time, so that the business can take immediate and proactive action in response to the customer. The ability to find patterns across data streams and automatically react on them allows a business to be more responsive to threats or opportunities and increases customer loyalty and retention while further entrenching the relationship. The benefits may be measured financially in terms of increased share of wallet, increased revenue, and reduced customer churn. It can also be measured in terms of customer satisfaction scores through voice of client surveys and likelihood to recommend through net promoter scores.

As referred to hereinafter, an event in the data stream is created by an entity/a user while using and interacting with a computing device. Alternatively, an event can be automatically generated by a machine or computing device. For a non-limiting example, an event can correspond to either a successful purchase of an item by a given user, or a failure to purchase an item by the user. For another non-limiting example, an event may correspond to a blood glucose reading in the medical field, where a glucose meter used by a patient is in communication with a system and each blood glucose reading of the glucose meter is uploaded to the system. For another non-limiting example, an event may correspond to a delayed or canceled flight for a flight passenger. For another non-limiting example, an event in the banking field may correspond to a customer service event such as an abandonment from a call center queue, an incomplete application for a credit card, and the closing of an account. In a further non-limiting example, an event may be generated by a device that can be but is not limited to a radio frequency identification (RFID) chip, a near field communication (NFC) device, a sensor, a server, where sensors may be used to perform one or more of: tracking the movement of goods in supply chain/logistics, monitoring the temperature, status of heating, ventilation, and air conditioning (HVAC) systems in in an office.

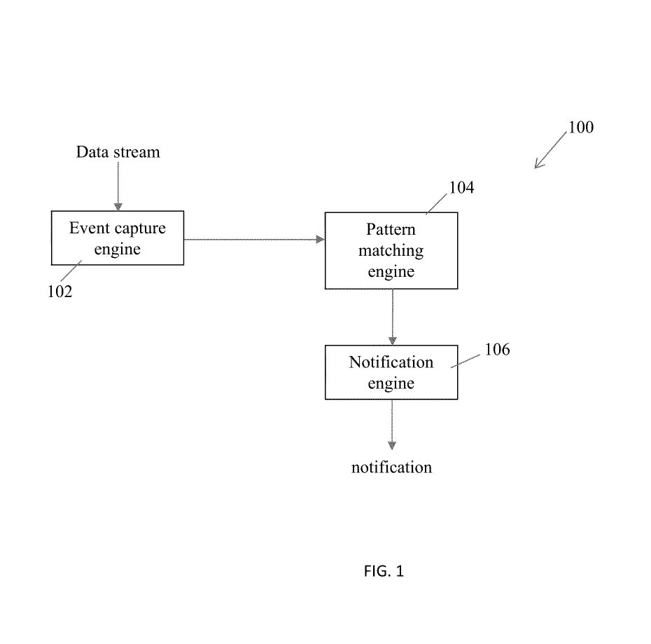

FIG. 1 depicts an example of a diagram of system 100 to support pattern detection in a single or multiple streams of data. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes an event capturing engine/unit 102, a pattern matching engine/unit 104, and a notification engine/unit 106. As used herein, the term engine or unit refers to software, firmware, hardware, or other component that is used to effectuate a purpose. The engine will typically include a computing unit/appliance/host and software instructions that are stored in a storage unit such as a non-volatile memory (also referred to as secondary memory) of the computing unit for practicing one or more processes. When the software instructions are executed, at least a subset of the software instructions is loaded into memory (also referred to as primary memory) by the computing unit, the computing unit becomes an apparatus for practicing the processes. The processes may also be at least partially embodied in the computing unit into which computer program code is loaded and/or executed, such that, the computing unit becomes a special purpose computing unit for practicing the methods. When implemented on a general-purpose computing unit, the computer program code segments configure the computing unit to create specific logic circuits. The processes may alternatively be at least partially embodied in a digital signal processor formed of application specific integrated circuits for performing the processes.

In the example of FIG. 1, each of the event capturing engine 102, the pattern matching engine 104, and the notification engine 106 can run on and/or share at least one host device (host) 102. Here, each host device 102 can be a computing device, a communication device, a storage device, a file/copy server, or any electronic device capable of running a software component. For non-limiting examples, a computing device can be but is not limited to a laptop PC, a desktop PC, a tablet PC, an iPod, an iPhone, an iPad, an Android-based device or a server machine. A storage device can be but is not limited to a hard disk drive, a flash memory drive, or any portable storage device.

In the example of FIG. 1, each of the event capturing engine 102, the pattern matching engine 104, and the notification engine 106 has a communication interface (not shown), which is a software component that enables the engines to communicate with each other and other devices over a network (not shown) following certain communication protocols, such as TCP/IP protocol. Here, the network can be a communication network based on certain communication protocols, such as TCP/IP protocol. Such network can be but is not limited to, internet, intranet, wide area network (WAN), local area network (LAN), wireless network, Bluetooth, WiFi, mobile communication network, or any other network type. The physical connections of the network and the communication protocols are well known to those of skill in the art.

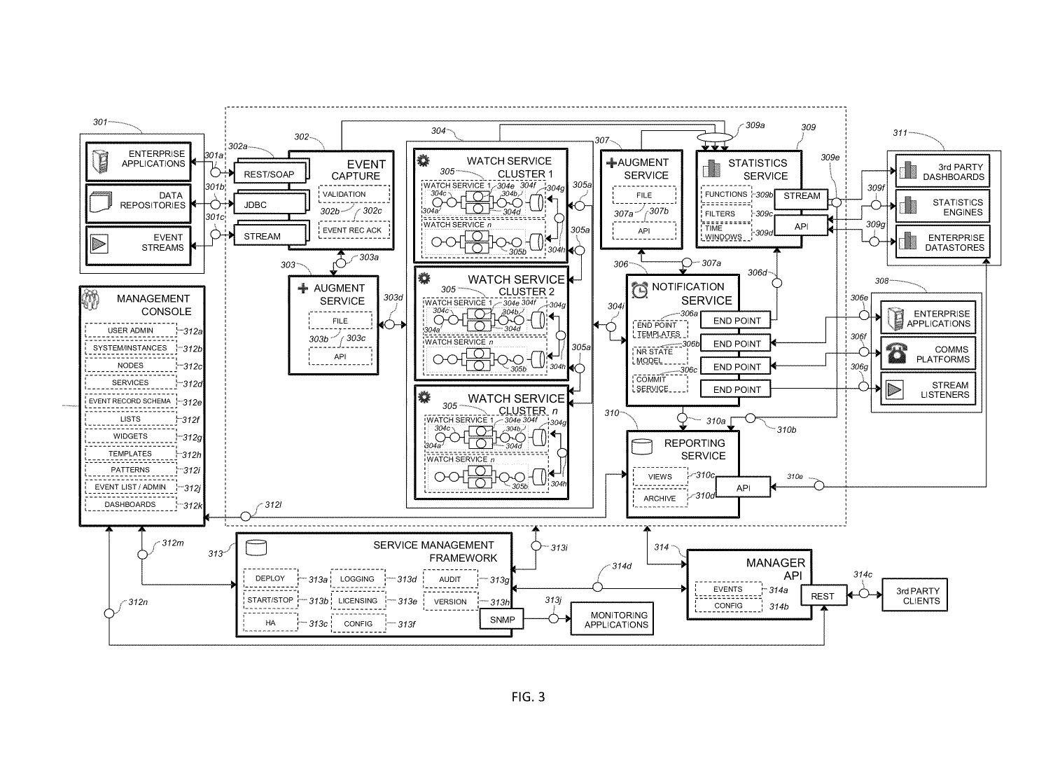

In the example of FIG. 1, the event capturing engine 102 is configured to receive and analyze a data stream to detect at least one event within the data stream, wherein the event occurred in relation with a given entity and/or indicative of the given entity. In addition to detecting the event from the data stream, the event capturing engine 102 is further configured to extract information about the detected event as well as information about the user/entity the event is related to (e.g., the user/entity that created the event). In some embodiments, instead of and/or in addition to detecting the event by itself, the event capturing unit 102 is configured to receive the event detected by an external data source/producer/application (shown in FIG. 3 discussed below) independent from the system 100, wherein the external data source is configured to analyze the data stream, detect the event in the data stream, and transmit the detected event to the event capturing engine 102.

In the example of FIG. 1, the pattern matching engine 104 is configured to accept the event detected by the event capturing engine 102 and to compare the event to a set of predefined patterns to determine if there is a match between the event and at least one of the predefined patterns. In some embodiments, a pattern may include a plurality of attributes and/or conditions (e.g., WHEN portion of the pattern) and a plurality of instructions on actions to be taken if the conditions are met (e.g., THEN portion of the pattern). The pattern matching engine 104 matches the event with each of the plurality of attributes. If a successful match between a pattern condition and the event is identified, the pattern matching engine 104 establishes a reference to a record of the event. If the event satisfies all of the conditions of at least one pattern, the pattern matching engine 104 determines a match between the event and the pattern. If the event satisfies some but not all conditions of the pattern, the pattern matching engine 104 keeps the reference to the record of the event until all conditions of pattern can be satisfied.

In the example of FIG. 1, the notification engine 106 generates a notification indicative of an entity that generated the event and/or the pattern that has been matched to the event once a match has been found between the event and the pattern by the pattern matching engine 104. As described above, the entity that generated the event may be a user or a device. The notification engine 106 then transmits the notification to a third party for further processing or storage with instructions from the pattern that has successfully matched with the event. In some embodiments, the notification engine 106 generates the notification when a single event is successfully matched to at least one pattern. In some other embodiment, the notification engine 106 generates the notification when at least two different events have each been matched to at least one respective pattern.

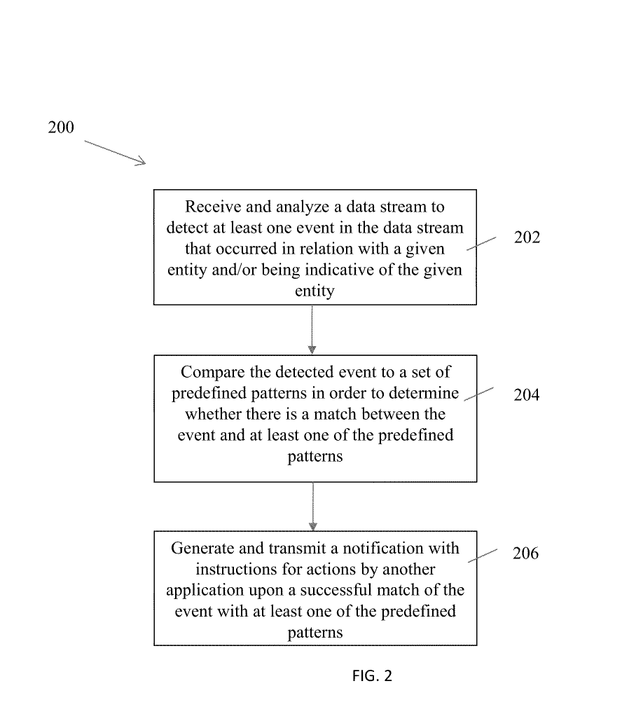

FIG. 2 depicts a flowchart of an example of a process to support pattern detection in a single or multiple streams of data. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202, where a data stream is received and analyzed to detect at least one event in the data stream that occurred in relation with a given entity and/or being indicative of the given entity. The flowchart 200 continues to block 204, where the detected event is compared to a set of predefined patterns in order to determine whether there is a match between the event and at least one of the predefined patterns. The flowchart 200 ends at block 206, where a notification is generated and transmitted with instructions for actions by another application upon a successful match of the event with at least one of the predefined patterns.

FIG. 3 illustrates an example of a platform 300 to support the implementation of the system 100 depicted in FIG. 1 for pattern detection in a single or multiple streams of data. As shown in the example of FIG. 3, the platform 300 comprises one or more of an augment service engine 303, a watch service engine 305, an augment service notification engine 307, a statistics engine 309, a reporting engine 310, a management console 312, a service management framework 313, and a managing application programming interface (API) 314, in addition to the event capturing engine 302, the pattern matching engine 304, and the notification engine 306 (each corresponding to the respective engine shown in FIG. 1). In some embodiments, the platform 300 is further connected to enterprise applications 308 and a third party reporting system 311.

As shown in the example of FIG. 3, the platform 300 is in communication with an external data source 301 for providing one or more events in a data stream to the event capturing engine 302. Here, the external data source 301 can be but is not limited to an external application such as an enterprise application, or an external system and/or platform such as an enterprise system, a data repository, a substantially real-time stream of data, and/or a similar source that contain event data. For non-limiting examples, the external system may comprise a customer relationship management (CRM) application, a workflow or business process management (BPM) application, an enterprise database, or data published via a data stream. These systems connect with the platform 300 via a set of platform libraries that enable sending or receiving event data via, for non-limiting examples, one or more of the following:
A Representational State Transfer (REST) interface, where the external data source 301 acts as a client to submit event information to the event capture engine 302 acting as a server (an event receiver) to receive the event data. In some embodiments, the data is sent in a low bandwidth message.
A Simple Object Access Protocol (SOAP) interface, which is similar to the REST interface but uses the Extensible Markup Language (XML) as the message format.
A Java Database Connectivity (JDBC) interface, which allows the event capture engine 302 to act as a client (an event collector) by proactively connecting with third-party database platforms and collecting event data using a query provided in the service configuration. In this case, the event capture engine 302 is configured to analyze the data streams to detect user events.
A Streaming API, which is configured to listen to a data stream provided by a third-party application for specific topics of interest. When found, a new event record is created and collected by the event capture engine 302 (an event collector). As in the case of the JDBC interface, by the event capture engine 302 is configured to analyze the data streams to detect user events.
   Here, all collectors and receivers are configured by the management console 312 or via the manager API 314 as a specific type of service, where each collector/receiver has a number of configuration parameters specific to the type of service.

In some embodiments, the external data source 301 is a source of structured event data, and the received and/or detected events in the data stream are organized in a key/value pairing format. The following illustrates one non-limiting example for a received event indicative of a canceled flight for a given customer:

“custId”: “720040740”,

“eventType”: “cnclflight”,

“source”: “mobile”,

“customerSegment”: “gold”,

“firstName”: “Jeff,

“phoneNumber”: “4155551212”,

“emailAddress”: “jeff@acme.com”

In the example of FIG. 3, the event capturing engine 302 comprises a set of inbound interfaces for collecting (where the event capturing engine 302 acts as a client) and receiving (where the event capturing engine 302 as a server) event data from the external data source 301. In some embodiments, the event capturing engine 302 is configured to validate all detected events against an event record schema including the attribute types to ensure that all of the required attribute(s) as defined in the schema have been provided to avoid downstream errors/fall-outs. For a non-limiting example, if an attribute is used by the pattern matching engine 304 as an integer, the event record schema configures this attribute accordingly as an integer. Here, the event record schema defines how the event data received and/or detected should be organized and stored for further processing and pattern matching by the pattern matching engine 104. In some embodiments, the event record schema is a list of attributes, including the attribute type such as a string or an integer, that make up an event record. An event record schema may include one or more of key attributes (i.e. attributes that are used in linking events together), list attributes (i.e. attributes that are defined by a finite list of values such as a customer segment), and additional attributes that are user-specific (e.g. a telephone number) and cannot be expressed in a finite list. In some embodiments, customers of a business are represented by key attributes in a stream of data, wherein the business configures patterns of customer behavior, and configures a reaction/action to each pattern. For non-limiting examples, the reaction can be a proactive outbound phone call, a text message, an email or other forms of communication to the customer. The platform 300 initiates these outbound communications by communicating with existing communication and collaboration platforms like computer telephony systems found in large contact centers, email management systems, or SMS/text messaging gateways.

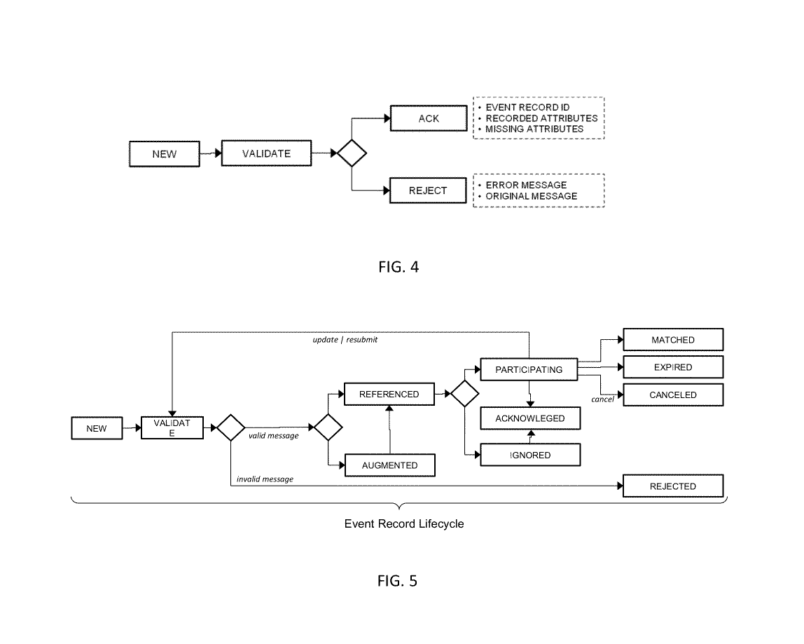

In some embodiments, the event capturing engine 302 is configured to transmit an acknowledgement receipt of the event data back to the external data source 301 once the event has been received and processed as illustrated by the example in FIG. 4. Here, the acknowledgement receipt includes one or more of an event record ID, attributes that match the event record schema and participate in a match (including the pattern ID in the case of a single pattern, or multiple IDs in the case of multiple patterns), and the attributes that were ignored or missing during pattern matching. The events sent or collected that do not pass validation by the event capturing engine 302 are rejected with an appropriate error message transmitted to the external data source 301 with the original message body.

Once the received event data has been validated, the event capturing engine 302 generates a record for an event (also referred to hereinafter as an event record) based on the event data, wherein the record for the event is an list of values ordered based on the event record schema. Unlike the event data, the record for the event only contains values (e.g., 720040740 in the example shown above), not the keys for the values (e.g. custId), wherein the order of the values matches the order of attributes defined by the event record schema. In some embodiments, the event capturing engine 302 provides the ability to modify the records of the events via modification to the event record schema, referred to as “in-band schema change.” When the event record schema is changed by a user, the existing records of the events maintain their current order of the values as well as a reference to the record schema before change, while any subsequent events will be ordered according to the changed schema.

In some embodiments, the augment service engine 303 in the example of FIG. 3 is configured to add one or more data attributes missing or unavailable in the event data from the external data source 301 as argumentation to the record for the event, wherein these additional attributes, such as a customer segment, are required for the event to be matched with a pattern by the pattern matching engine 304. It should be understood that the augment service engine 303 is an optional unit and is only required if the external data source 301 is missing one or more event record attributes. In this case, instead of updating the external data source 301 to include the missing attributes, the augment service engine 303 adds the missing attribute values for the user to the record of the event. It should also be understood that not all event records may require augmentation and the augment service provided the augment service engine 303 is associated to one or more collectors and/or receivers of the event capturing engine 302. Once configured, any events collected or received passes through the augment service engine 303 prior to be sent to the pattern matching engine 304.

In some embodiments, the augment service engine 303 is configured to provide the additional attributes by either uploading them via a file or through the API 307b. The following presents an example of a tabular data file of attributes to uploaded:

| Customer ID, | first name, | last name, | state, | time zone |
|---|---|---|---|---|
| 720040740, | Jeff, | Thompson, | CO, | MST |
| 720040741, | Sam, | Allen, | ON, | EST |
| 720040742, | Alex, | Thompson, | NY, | EST |

Once uploaded, the file is stored either in a storage unit such as in memory for efficient access by the augment service engine 303, or on a non-volatile secondary storage such as a disk.

During operation, the augment service engine 303 is configured to perform a lookup function using the event record attributes as input. When a match is found in the first column of the augment file (e.g., customer ID in the example above), the augment service engine 303 returns all values in that row as either new attributes for the event record, or replacing the values in the event record with those in the augment file. In some embodiments, the augment service engine 303 is configured to have multiple files in a chain, where the data attributes added in a given record/augmentation can be used as inputs for subsequent augmentations.

In some embodiments, the augment service notification engine 307 in the example of FIG. 3 is configured to perform a similar function of adding one or more data attributes not available in the event data from the external data source 301 to the record for the event, wherein these additional attributes, such as a telephone number for an outbound call, are required to complete an outbound notification by the notification engine 306. Splitting the augment service into two separate services ensures that the size of the event record stored in-memory by the pattern matching engine 304 is substantially optimized/reduced by not storing attributes not required for matching a pattern. Prior to sending any notification through an end point, the augment service notification engine 307 is engaged to fetch missing attributes required for the notification, and the augment list for notifications is managed through a list upload or via API.

In the example of FIG. 3, the pattern matching engine 304 is configured to receive and store the records of the events, analyze the records of the events in the data stream for pattern matching, and to initiate communications and/or actions when matches are found. In some embodiments, the pattern matching engine 304 comprises a plurality of watch service engines 305 shown in the example of FIG. 3, wherein the watch service engines 305 each operates as a single process and/or together as one or more watch service clusters in a clustered environment. Here, each watch service engine 305 is configured to manage lifecycle of the records of the events, including but not limited to, state of the records the events and their matches, until they have either been matched with one or more predefined patterns, have expired due to a time-out, or ignored as they do not match any of the predefined patterns.

FIG. 5 depicts an example of various stages in a lifecycle of an event record:
New, where event data from the external data source 301 is received by the event capturing engine 302.
Validated, where the event data is being validated against the event record schema. Invalid event records are immediately rejected with an appropriate error message back to the external data source 301.
Augmented, where the event data is augmented with additional information as described above if required.
Referenced, where the data contained in the event record is referenced by the pattern matcher 304d configured for a “WHEN” condition if the event record matches the “WHEN” condition.
Matched, where the event record being referenced have met all conditions on the pattern and is being sent to the notification engine 306.
Expired, where the event record is expired and removed from its corresponding pattern matcher 304d when a time window (e.g.: within a predetermined period of time) of the pattern has expired.
Canceled, where an event record that is actively being referenced by one or more pattern matchers 304d is canceled through the Managing API 134 by a user and removed from the watch service engine 305.
Updated/Resubmitted, where the event records can be updated by a third-party client or a user of the management console 312 via an update function of the managing API 314. An update to an event record automatically causes that event record to be resubmitted and sent back to the validation step. In some embodiment, the event record must be in a referenced state in order to be updated. In some other embodiments, a client/user can simply resubmit an event record in case of an update to a pattern. In this case, the event record must be in a referenced state to be resubmitted.
Ignored, where the event record is ignored if it has passed through all configured pattern matchers 304d and does not match any of the pattern conditions.

In some embodiments, one of the plurality of watch service engines 305 in the pattern matching engine 304 is configured to serve as a leading (primary) engine for pattern matching of the events for high availability (HA) and resiliency of the pattern matching engine 304, while other watch service engines 305 serve designated followers/backups for the leading engine. When the leading watch service engine 305 fails, the other watch service engines 305 negotiate a leader-election among themselves and continue substantially uninterrupted processing of the received records of the events.

In some embodiments, two or more of the plurality of watch service engines 305 are configured to operate in a cluster mode as one cluster and to share the load across the engines in the cluster. When one of the watch service engines 305 in the cluster fails, the other watch service engines 305 in the same cluster automatically rebalance the load and continue substantially uninterrupted processing of the received records of the events. When the watch service engine 305 is added back to the cluster, the load is rebalanced across all members of the cluster.

In some embodiments, the watch service engines 305 continue to operate as long as there is a quorum, or majority of services are still operating in order to ensure a substantially high HA guarantee. For a non-limiting example, if the total number of watch service engines 305 in a cluster on startup was five, and three of remain operating, the pattern matching engine 304 continues to operate. If the number drops to two, i.e. below the majority, the pattern matching engine 304 may stop to operate until a majority is restored. Using the service management framework 312, the pattern matching engine 304 instructs the event capture engine 302 to stop accepting any new events to ensure a graceful shutdown of the operation.

In some embodiments, each watch service engine 305 comprises a network processor (NP) 304a, wherein the NP 304a represents a high-performance, asynchronous transport layer for receiving the records of the events from a collector and/or a receiver of the event capturing engine 302 directly, or via the augment service provided by the augment service engine 303. In some embodiments, event records may also be distributed across the clusters by using any adequate distributed computation techniques on an attribute of the event records to an even distribution of event records across the watch service engines 305.

In some embodiments, each watch service engine 305 also comprises a dispatcher (DS) 304c configured to run the records of the events through a plurality of pattern matchers 304d, one designated for each enabled pattern, wherein each pattern matcher 304d evaluates the received event record against a respective pattern. When an event record matches the pattern's condition (e.g., the condition following “WHEN” that acts as a condition when evaluating the event record), the pattern matcher 304d references the event record as a match. For a non-limiting example, a “WHEN” condition can be “For any given Gold Customer”. For a non-limiting example, a “WHEN” condition may contain nesting such as “If within two hours, the following have occurred and a call has not been established: a) for any high priority customer with at least one upgrade opportunity at negotiation review stage and has been unsuccessful contacting their account representative at least four times.” Please note that an event record may match with more than one pattern and therefore be referenced as matched by the more than one pattern. In this case, only a single copy of the event record is retained and pattern matcher 304d retains references to the patterns. When the conditions of one or more pattern matchers 304d are satisfied, an action is initiated. If an event record passes through the pattern matcher 304d with no reference to a pattern being made, the event record is then ignored.

In some embodiments, each watch service engine 305 also comprises a retirer (RT) 304e that retires events that were participating to a pattern match, but are no longer meeting a “WHEN” condition (a time-out), i.e., when the time window (e.g., within 60 minutes) has expired or canceled. The retirer 304e is passive and will only act to remove an event from the pattern matcher 304d when an additional incoming event with the same key attribute comes in whose time stamp is longer than the time stamp of the retiring event.

In some embodiments, all referenced event records are stored in a (transient) memory of the watch service engine 305. When the memory reaches a configured threshold (via service configuration in the management console 312), the watch service engine 305 automatically begins to swap the event records to a non-transient disk, and an alert may be raised to alert system administrators of the situation. The swapping has no substantial impact on the performance of the watch service engine 305 and it stops when the amount of memory being utilized drops below the threshold. The memory is also released as event records exit a referenced status to either matched (sent to the notification engine 306), expired, canceled or ignored status.

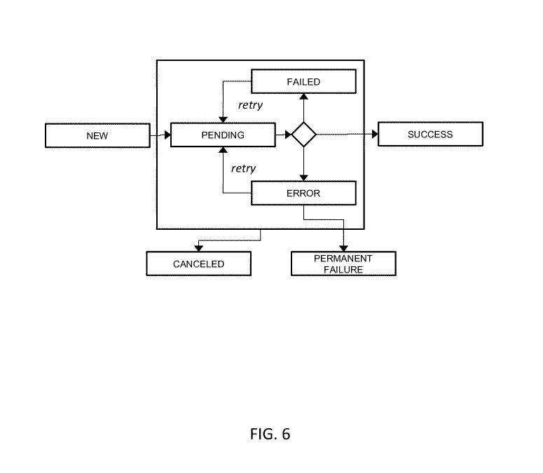

In the example of FIG. 3, the notification engine 306 is configured to process the matched event records received from the pattern matching engine 304 as illustrated in FIG. 6. The notification engine 306 is configured to retrieve instructions from the “THEN” portion of the matched pattern, generate and send a notification and/or request to one or more third party enterprise applications 308 through a plurality of end points to take an action according to the instructions. For non-limiting examples, the action can be but is not limited to, to make a call, to send an email or SMS to the customer, and/or other types of notifications enabled by the end-points. In some embodiments, the end points are configured through the management console 312 according to configuration elements stored in an end-point template, which provides the console 312 with parameters to display in the user interface as well as the logic and libraries required to establish and maintain a connection to the enterprise applications 308. The end point template also defines logic for which event record attributes are to be passed as variables in the form of the notification/request to the enterprise applications 308. For a non-limiting example, if a customer's telephone number is required to initiate a call, this event record attribute will be defined in the end-point configuration.

In some embodiments, the notification engine 306 not only transmits the notification to the third party for processing, but also accepts information back from the third party that it may use in further processing via the bi-directional end points 306e and 306f depicted in FIG. 3. For a non-limiting example, the notification engine 306 can transmit a customer identification number to a customer relationship management (CRM) system to request customer segment and contact information such as an email address and a telephone number. The returned values are used in subsequent processing by the notification engine 306.

In some embodiments, the enterprise applications 308 in the example of FIG. 3 comprise external systems configured to take actions upon receiving a communication/notification from the notification engine 306. For non-limiting examples, the external systems may comprise one or more of enterprise applications such as customer relationship management (CRM) applications, communication and collaboration platforms (e.g.: telecommunication, email, video conferencing, text/SMS), and any system listening to a stream of notifications published by the notification engine 306.

In some embodiments, the statistics engine 309 in the example of FIG. 3 is configured to collect performance statistics from various components of the platform 300 including but not limited to the event capturing engine 302, the augment service engine 303 and 307, the pattern matching engine 304, and the notification engine 306. Once collected, the statistics engine 309 applies a variety of mathematical/statistical functions/operators including but are not limited to sum, min, and max to the performance statistics to calculate statistically useful information related to processing events and pattern matching, via interfaces, and makes these statistics available to internal and external to clients/users via either data streams or APIs.

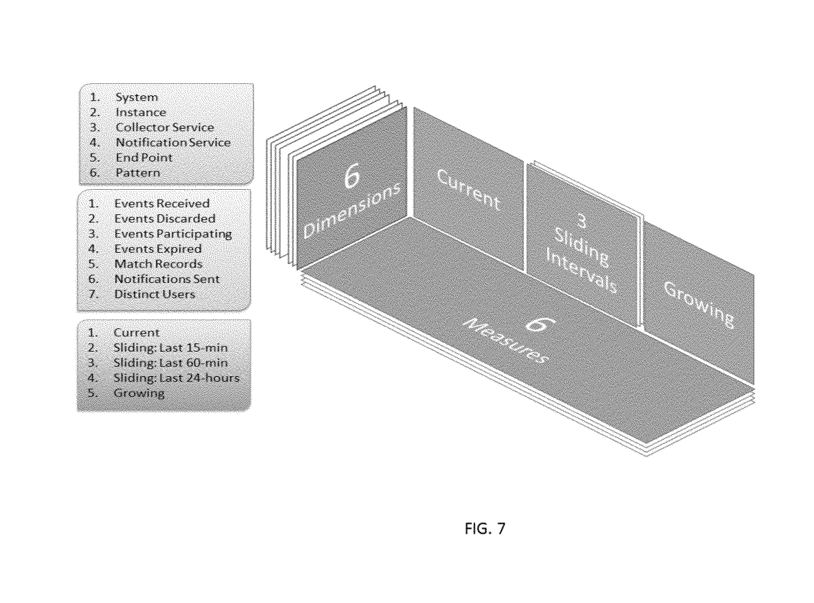

In some embodiments, the statistics calculated by the statistics engine 309 is associated with one of the following dimensions or configuration objects as shown by the example of FIG. 7: system, where the statistics engine 309 filters these calculated statistics for a given dimension over a time interval. Here, the dimensions represent the core objects against which measures are calculated and the core dimensions include but are not limited to: a system, which is the top most level of a platform configuration having one or more tenants, and the one or more tenants, which share a single instance of the software running on one or more physical or virtual servers (nodes as defined below) and managed by a system owner. Here the tenants can be used to deploy the software production, staging and test configurations, or to service specific lines of business such as card services, retail banking and discount brokerage for a financial services customer. All tenants leverage common platform capabilities including but not limited to event capture collector/receiver services, notification services, end points, and pattern or patterns configured in a tenant containing the logic for matching events.

In some embodiments, the statistics engine 309 is also configured to filter the calculated statistics based on one or more of the following measures:
Events received, which are event records received from the external data source 301.
Events ignored, which are event records received but not associated with any pattern.
Events participated, which are events records contributing to a pattern match, i.e. one or more of the event record attributes that match a “when” condition in one or more patterns. Events participated form a subset of the events received, but not necessarily of the events discarded. When it is participating in more than one pattern match, an event record is only counted as one.
Events expired, which are event records that were participating to a pattern match, but the pattern time window has expired and the event records have been removed from the watch list.
Match records, which are records created when a pattern is matched.
Notifications sent, which is a count specific to an end point, pattern, tenant or any other dimension as a filter.
Distinct users, which are users associated with event records via the key attributes as measured by the sum, min/max, or other operators on distinct key attributes.

In some embodiments, the statistics engine 309 filters these calculated statistics over a specified time window/interval such as the last 24 hours or the last 15 minutes. Types of the time window include but are not limited to:
Current Interval, which is a window that includes events as of the current moment in time;
Sliding Interval, which is a time period that stretches back in time from the present. For a non-limiting example, a sliding window of 15 minutes includes any events that have occurred in the past 15 minutes. As they fall out of the sliding time window (because they occurred more than two minutes ago), events will no longer be matched against rules using this particular sliding window;
Growing Interval, which is an interval that includes events until a threshold time has been reached and the measure will be reset to zero. For a non-limiting example, a growing interval may require one or more inputs for the hour the growing interval will be reset.

In some embodiments, the statistics engine 309 utilizes functions to measure for a given dimension or set of dimensions in a specified time window for a given set of dimensions/filters. Such functions include but are not limited to,
Count, which is the number of events collected per second for the tenant;
Count Distinct, which is the number of distinct users associated with the events participated over a time period;
Min, which is the number of match records during a time interval for a specific pattern;
Max, which is the number of notifications sent via an end point during a time interval for a specific pattern;
Average: 4250 events collected per second for current day.

In some embodiments, the statistics engine 309 makes the statistics information available to clients via an API (e.g., a RESTful API) or through a statistics stream that publishes statistical information to a third party dashboard on a continuous basis. The RESTful API can also be utilized to create customer statistical objects.

In some embodiments, the notification engine 306 is also configured to commit to a reporting service database 310d via the reporting engine 310 all pattern matching details and records of the events that contributed to the pattern match along with the corresponding actions taken as a result of the pattern matching and notification for reporting purposes. For each match, the reporting engine 310 stores matched event records that contributed to the matched pattern, creates a match record that contains information associated with the match and a notification record for each end point. The reporting engine 310 is also configured to provide such information to third-party enterprise databases (not shown) via views. In some embodiments, the reporting engine 310 is also configured to archive data according to an archive policy set in the service configuration. In some embodiments, the reporting engine 310 collaborates with and receives information from the notification engine 306 and statistics results that are required for historical reporting from the statistics engine 309 via a streaming API. The information received is then stored and made readily available to third party reporting systems such as third party dashboards (e.g. third party data visualization), statistical engines (e.g. call center statistics engine) and enterprise data warehouses or databases.

In some embodiments, all configuration and administration activities of the platform 300 are performed through the management console 312 in the example of FIG. 3, which comprises a thin-client, role-based application/graphic user interface. All changes in the platform 300 are made and recorded by communicating with the service management framework 313. In some embodiments, the management console 312 is configured to provide a user with some data from the reporting engine 310 in, for a non-limiting example, a dashboard format, and a list view of all patterns and actions taken. The management console 312 is also configured to allow the user to manage events contributing to a pattern match through the managing API 314. The following is a list of entities and functions provided by the management console 312:
User administration, which is a user interface that provides the ability to create, delete, and update users of the management console 312. Users are assigned to one or more and tenants, and granted permissions (e.g.: create services, view-only, cancel event records) through a role such as system administrator, tenant administrator, business analyst, etc.
Tenants, where the platform 300 operates in a multi-tenant capacity and the management console 312 provides an authenticated user with the ability to create, update or deleted tenants via a user interface.
Nodes, wherein each node represents a virtual or physical computer or server platform and provide the enabling run-time foundation for all platform services, including the management console.
Services, where a user interface for configuring service properties such as ports, username/password, OAUTH for authentication, nodes including primary and backup, and access for service management framework 313 functions such as start/stop of services.
Event record schema, which provides the ability to define the attributes that make up an event record. Each attribute is assigned a type like a string or number. For a non-limiting example, an event record schema may comprise a key attribute, a list of attributes, and optional attributes. A key attribute represents an event record attribute that groups events together for pattern matching, and is therefore a mandatory attribute in an event record. One example of a key attribute consists in a customer identification number. If a list has been configured with the event record attribute option selected (or checked), it will be available as a list attribute selection. The optional attributes are attributes that are not configured as a list, but will be present in the event information. A list of optional attributes may comprises emails, addresses, etc.
Lists, which is a key/value pair list of frequently used configuration elements in patterns. For example, a customer segment list may have gold, silver and bronze where the key is the user-friendly display and the value is what is received from the external data source 301. The use of lists ensures the validity of inputs during the configuration of patterns and event record map.
Widgets, which are the core building blocks for patterns and define how patterns are displayed to a business user, and contain the instructions for the watch service responsible for finding pattern matches. Widgets are written by a technical resource with a programming background and familiarity with a domain specific language (DSL). Widgets have a parent/child relationship where a widget can be a top-level or parent to one or more children. The relationship between top-level parent widgets is an implied “and” meaning all of the top-level widgets must be satisfied before a notification is sent. The DSL is a domain-specific language for matching events to patterns and sending notifications. The language includes a number of functions such as count, specify the type of event to match, min/max, followed-by, cancel match if. For notifications, parallel and sequential notification, nested, conditional branching are supported.
Templates, which provide business users a quick start when creating a pattern. Templates include a number of widgets that can be either “when” or “then” types and specify a logical ordering across the widgets. For a non-limiting example, a top-level widget such as “For any given customer” or “All of the following:” would have a number of child when widgets such as “Customer Segment is Gold”, “Failed check-in more than 3 times” and “these Occurred in the last 2 hours.”
Patterns, which define the relationship between a set of events over a time period. A failed check-in and a ticket cancellation in the last 1-hour period each represent a pattern. When events collected match a pattern, the event detecting platform sends a notification to an enterprise system 8 in order to call, e-mail or SMS the customer. In one embodiment, patterns are created by business users in an intuitive user interface that masks the complexity behind the widgets previously configured. The approach is similar to using building blocks, add/remove the widgets required to meet business requirements without having to worry about coding. Once saved, the widgets are combined into a pattern instruction and sent to a pattern matcher.
Watch list, which is a user interface showing all matches by retrieving information from the reporting engine 310 and referenced event records contributing to a pattern match by requesting this information through a “GET” command processed by the managing API 314 and to canceled, resubmitted, or update reference event records in the pattern matching engine 304.
Dashboard, which is a graphical display of key statistics over time, using the information provided by the reporting engine 310.

In some embodiments, all configuration changes are made through a user interface (UI) and dispatched to the platform 300 via the service management framework 313 in the example of FIG. 3, wherein the service management framework 313 enables deploying new services, starting/stopping services, high availability configuration, and framework licensing. For a non-limiting example, the service management framework 313 is configured to provide a centralized library of functionality for administering services across the platform 300 with simple network management protocol (SNMP), or other such standards that may exist, gateway out to third party monitoring applications. Examples of such functionalities include but are not limited to:
Deploy, where changes to the configuration of any of the system services are saved in configuration and the runtime services are automatically updated with this new information.
Start/stop service, which is the ability to start a service, such as a watch service, that is installed and made available to one or more tenants, but not started. The service management framework 313 detects the current state of a service, like whether it is currently stopped, and will only enable a valid command based on its current state. For example, a stopped service can only be started.
HA manager, which is an agent that is substantially constantly polling services to ensure that the services are still operative. If a response (pong) to a request (ping) is not received, the HA Manager initiates a request to activate the service's backup.
Logging, which is a mechanism to collect information from all services, stored centrally, and made available to a user through management console 312, or via SNMP alerts to third party monitoring applications.
License manager, which ensures that customers have rights, or entitlement to use the installed services. If the license has expired, then the license manager sends a stop command to stop the service(s).
Configuration, where all system configurations are stored in a repository that may be replicated. All changes are recorded with the information on the changes made, including the user and versioned for rollback.
Audit, where all changes are recorded through the logging service and stored by the audit service.
Version, where any changes to a service configuration are stored as a new version for that service.

In some embodiments, the managing API 314 in the example of FIG. 3 is an programmable application interface (gateway) that enables the management console 312 and/or an authenticated third-party clients to update, resubmit, or cancel referenced or matched event records. In addition, the managing API 314 is also configured to perform all of the activities in the management console 312 via a plurality of functions including but not limited to starting/stopping services, creating new services or patterns, updating augment list, disabling a pattern, retrieving information on the records of the events and updating configuration items.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system for detecting patterns in at least one data stream, comprising:
an event capturing engine running on a host, which in operation, is configured to receive and analyze a data stream to detect at least one event in the data stream that occurred in relation with a given entity and/or indicative of the given entity;
a pattern matching engine running on a host, which in operation, is configured to compare a record of the detected event to a set of predefined patterns to determine whether there is a match between the event and at least one of the predefined patterns;
a notification engine running on a host, which in operation, is configured to generate and transmit a notification with instructions on actions upon a successful match of the event with at least one of the predefined patterns.

2. The system of claim 1, wherein:
the event capturing engine is configured to receive the event detected by an external data source instead of and/or in addition to detecting the event by itself.

3. The system of claim 2, wherein:
the event capturing engine is configured to transmit an acknowledgement receipt of the event back to the external data source once the event has been received and processed.

4. The system of claim 1, wherein:
the event capturing engine is configured to validate the record of the detected event against an event record schema to ensure that all required attributes as defined in the event record schema have been provided, wherein the event record schema defines how the event received and/or detected should be organized and stored for further processing and pattern matching.

5. The system of claim 4, wherein:
the event capturing engine is configured to perform in-band schema change by modifying the event record schema to accommodate modification to the record of the event.

6. The system of claim 1, further comprising:
an augment service engine configured to add one or more data attributes missing or unavailable in the event data as argumentation to the record of the event, wherein these additional attributes are required for the event to be matched with one of the predefined patterns.

7. The system of claim 1, wherein:
each of the predefined patterns includes a plurality of attributes and/or conditions to be matched with the event and the instructions on actions to be taken if the conditions are met.

8. The system of claim 1, wherein:
the pattern matching engine is configured to manage lifecycle of the record of the event until the event has been matched to one of the predefined patterns, expired due to a time-out, or ignored as it does not match any of the predefined patterns.

9. The system of claim 1, wherein:
the pattern matching engine is configured to run the record of the event through a plurality of pattern matchers, wherein each of the pattern matchers evaluates the record of the event against one of the predefined patterns.

10. The system of claim 1, wherein:
the notification engine is configured to retrieve the instructions from “THEN” portion of the matched pattern, generate and send the notification to one or more third party applications through a plurality of end points to take the actions according to the instructions.

11. The system of claim 1, wherein:
the notification engine is configured to accept information back from the one or more third party applications through the plurality of end points for further processing.

12. The system of claim 1, wherein:
the notification engine is configured to commit to a reporting service database one or more of the record of the event, pattern matching details, the corresponding actions taken as a result of the pattern matching and the notification for reporting purposes.

13. The system of claim 1, further comprising:
a statistics engine configured to collect performance statistics from various components of the system and to calculate statistical information related to the event and the matched pattern, wherein the calculated the statistics is associated with one or more of a plurality of dimensions over a time interval, wherein the dimensions include a system, which is the top most level of a platform configuration having one or more tenants, and the one or more tenants, which share a single instance of the software running on one or more physical or virtual servers and managed by a system owner.

14. A computer-implemented method for detecting patterns in at least one data stream, comprising:
receiving and analyzing a data stream to detect at least one event in the data stream that occurred in relation with a given entity and/or indicative of the given entity;
comparing a record of the detected event to a set of predefined patterns to determine whether there is a match between the event and at least one of the predefined patterns;
generating and transmitting a notification with instructions on actions upon a successful match of the event with at least one of the predefined patterns.

15. The computer-implemented method of claim 14, further comprising:
receiving the event detected by an external data source.

16. The computer-implemented method of claim 15, further comprising:
transmitting an acknowledgement receipt of the event back to the external data source once the event has been received and processed.

17. The computer-implemented method of claim 14, further comprising:
validating the detected event against an event record schema to ensure that all required attributes as defined in the event record schema have been provided, wherein the event record schema defines how the event received and/or detected should be organized and stored for further processing and pattern matching.

18. The computer-implemented method of claim 17, further comprising:
performing in-band schema change by modifying the event record schema to accommodate modification to the record of the event.

19. The computer-implemented method of claim 14, further comprising:
adding one or more data attributes missing or unavailable in the event data as argumentation to the record for the event, wherein these additional attributes are required for the event to be matched with one of the predefined patterns.

20. The computer-implemented method of claim 14, further comprising:
managing lifecycle of the record of the event until the event has been matched to one of the predefined patterns, expired due to a time-out, or ignored as it does not match any of the predefined patterns.

21. The computer-implemented method of claim 14, further comprising:
running the record of the event through a plurality of pattern matchers, wherein each of the pattern matchers evaluates the record of the event against one of the predefined patterns.

22. The computer-implemented method of claim 14, further comprising:
retrieving the instructions from “THEN” portion of the matched pattern, generate and send the notification to one or more third party applications through a plurality of end points to take the actions according to the instructions.

23. The computer-implemented method of claim 22, further comprising:
accepting information back from the one or more third party applications through the plurality of end points for further processing.

24. The computer-implemented method of claim 14, further comprising:
committing to a reporting service database one or more of the record of the event, pattern matching details, the corresponding actions taken as a result of the pattern matching and the notification for reporting purposes.

25. The computer-implemented method of claim 14, further comprising:
collecting performance statistics from various components and calculating statistical information related to the event and the matched pattern, wherein the calculated the statistics is associated with one or more of a plurality of dimensions over a time interval, wherein the dimensions include a system, which is the top most level of a platform configuration having one or more tenants, and the one or more tenants, which share a single instance of the software running on one or more physical or virtual servers and managed by a system owner.

26. A non-transitory computer readable medium having software instructions stored thereon that when executed cause a system to:
receive and analyze a data stream to detect at least one event in the data stream that occurred in relation with a given entity and/or indicative of the given entity;
compare a record of the detected event to a set of predefined patterns to determine whether there is a match between the event and at least one of the predefined patterns;
generate and transmit a notification with instructions on actions upon a successful match of the event with at least one of the predefined patterns.
